(19) United States
(12) Patent Application Publication
(10) Pub. No.: US 2018/0076932 A1
(43) Pub. Date: Mar. 15, 2018

(54) TRANSMISSION DEVICE AND TRANSMISSION METHOD

(71) Applicant: FUJITSU LIMITED, Kawasaki-Shi (JP)

(72) Inventor: Takuro OKADA, Kawasaki (JP)

(73) Assignee: FUJITSU LIMITED, Kawasaki-shi (JP)

(21) Appl. No.: 15/685,660

(22) Filed: Aug. 24, 2017

(30) Foreign Application Priority Data
Sep. 13, 2016 (JP) 2016-178903

(51) Int. Cl. H04L 1/00; H04L 5/00; H04L 12/40; H04L 12/935; H04L 12/947; H04L 12/931; H04L 12/933

(52) U.S. Cl. CPC H04L 1/0083; H04L 5/0001; H04L 12/40156; H04L 49/15; H04L 49/25; H04L 49/20; H04L 49/30

(57) ABSTRACT

A transmission device includes a memory, and a processor coupled to the memory and the processor configured to generate a first frame having first slots to be transmitted to another transmission device through a first path, and a second frame having second slots to be transmitted to the another transmission device through a second path, arrange data into the first or second slots, notify the another transmission device of first information of an output-destination of the data arranged into the first slots through the first path in a case where the data is arranged into the first slots, and notify the another transmission device of second information of a correspondence-relationship between the second slots and the output-destination through the second path, in a case where the data is arranged from the first slots into the second slots, before the data being arranged from the first slots to the second slots.

### CROSS-REFERENCE TO RELATED APPLICATION

This application is based upon and claims the benefit of priority of the prior Japanese Patent Application No. 2016-178903, filed on Sep. 13, 2016, the entire contents of which are incorporated herein by reference.

### FIELD

The embodiments discussed herein are related to a transmission device and a transmission method.

### BACKGROUND

In the optical internetworking forum (OIF), studies are being made on the Flexible Ethernet as “Flex Ethernet” technique, in which client signals at transmission rates that are not prescribed as a data rate of the Ethernet as an international standard are multiplexed into one or more signals of 100 Gigabit Ethernet (GbE (registered trademark, hereinafter similar to the above)) to be accommodated. As such client signals, Ethernet (registered trademark, hereinafter similar to the above) signals of 10 gigabits per second (Gbps), 40 (Gbps), 25 (Gbps), and so forth are cited. Note that the group of one or more signals of 100 GbE is called “FlexE Group.”

Regarding the signal multiplexing technique, a technique in which Ethernet signals of plural channels are multiplexed to be converted to a payload of a synchronous digital hierarchy (SDH)/synchronous optical network (SONET) frame is known in Japanese Laid-open Patent Publication No. 2006-5506, for example.

### SUMMARY

According to an aspect of the invention, a transmission device in a transmission system in which a first transmission device transmits frames to a second transmission device, the transmission device as the first transmission device includes a first memory, and a first processor coupled to the first memory and the first processor configured to generate a first frame having a plurality of first slots to be transmitted to the second transmission device through a first path, and a second frame having a plurality of second slots to be transmitted to the second transmission device through a second path, arrange data into one of the plurality of first slots and the plurality of second slots, notify the second transmission device of first information of an output destination of the data arranged into the plurality of first slots through the first path in a first case where the data is arranged into the plurality of first slots, and notify the second transmission device of second information of a correspondence relationship between the plurality of second slots and the output destination through the second path, in a second case where the data is arranged from the plurality of first slots into the plurality of second slots, before the data being arranged from the plurality of first slots to the plurality of second slots.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating one example of a transmission system;

FIG. 2 is a configuration diagram illustrating an application example of a signal multiplexing device and a signal demultiplexing device;

FIG. 3 is a configuration diagram illustrating an application example of the signal multiplexing device and the signal demultiplexing device;

FIG. 4 is a configuration diagram illustrating an application example of the signal multiplexing device and the signal demultiplexing device;

FIG. 5 is a configuration diagram illustrating one example of a multiplexed frame;

FIG. 6 is a diagram illustrating one example of multiplexing processing of client signals;

FIG. 7 is a diagram illustrating one example of a FlexE overhead;

FIG. 8 is a configuration diagram illustrating one example of a signal multiplexing device;

FIG. 9 is a configuration diagram illustrating one example of a multiplexing unit;

FIG. 10 is a configuration diagram illustrating one example of a signal demultiplexing device;

FIG. 11 is a diagram illustrating one example of deletion of a client signal;

FIG. 12 is a diagram illustrating one example of multiplexing processing after a deletion of a client signal;

FIG. 13 is a sequence diagram illustrating one example of deletion processing of a client signal;

FIG. 14 is a diagram illustrating one example of path switching of a client signal;

FIG. 15 is a diagram illustrating one example of multiplexing processing after a path switching of a client signal;

FIG. 16 is a sequence diagram illustrating one example of path switching processing of a client signal;

FIG. 17 is a diagram illustrating an example of a transmission system in a case of transmitting plural pairs of client signals at the same transmission rate;

FIG. 18 is a diagram illustrating one example of multiplexing processing in a case in which slots of multiplexed frames are fixed on each transmission rate basis; and

FIG. 19 is a diagram illustrating modification examples of contents of a calendar.

### DESCRIPTION OF EMBODIMENTS

According to the “Flex Ethernet” technique, the respective 100-GbE signals in which client signals are accommodated are transmitted via different paths. To efficiently use the band of the 100-GbE signal, it is preferable to accommodate the respective client signals in the same 100-GbE signal if the total of the bandwidth of the respective client signals is equal to or smaller than 100 (Gbps), for example.

However, when the accommodation destination of a client signal that is being transmitted is changed in order to cause the respective client signals to be accommodated in the same 100-GbE signal, the path of the client signal is switched. Therefore, for example, an error possibly occurs due to the influence of the path switching on another client signal.

Embodiments of techniques that are disclosed by the present application and may reduce the error that occurs due to path switching will be described in detail below based on the drawings. Note that the disclosed techniques are not limited by the embodiments. Furthermore, the embodiments represented below may be combined as appropriate within a range in which contradiction is not caused.

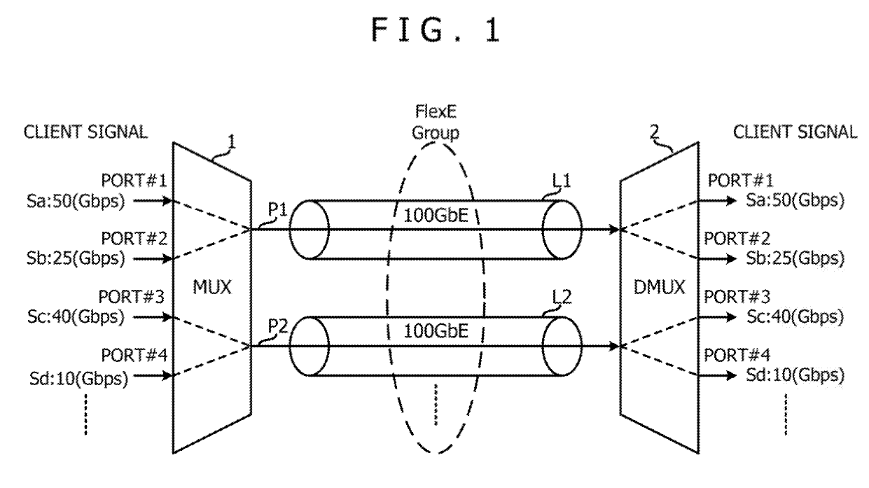

FIG. 1 is a configuration diagram illustrating one example of a transmission system. The transmission system includes a signal multiplexing device (MUX) 1 that multiplexes and transmits client signals Sa to Sd that are one example of data and a signal demultiplexing device (DMUX) 2 that receives and demultiplexes the multiplexed client signals Sa to Sd. Note that the signal multiplexing device 1 and the signal demultiplexing device 2 are each one example of a transmitting device.

To ports #1 to #4 of the signal multiplexing device 1, the client signals Sa to Sd at transmission rates that are not prescribed as a data rate of the Ethernet as an international standard are input. The signal multiplexing device 1 multiplexes the respective client signals Sa to Sd into multiplexed frames based on a “Flex Ethernet” technique, for example, and transmits the multiplexed frames to the signal demultiplexing device 2 via two physical communication lines L1 and L2 of 100 GbE as one example.

The communication line L1 is provided in a path P1 (for example, optical fiber) that couples the signal multiplexing device 1 and the signal demultiplexing device 2 and the communication line L2 is provided in another path P2 (for example, optical fiber) that couples the signal multiplexing device 1 and the signal demultiplexing device 2. The communication lines L1 and L2 transmit Ethernet frames (Ethernet signals) based on a technique of 100 GBASE-R, for example. The path P1 is one example of a first path and the path P2 is one example of a second path.

The communication lines L1 and L2 of 100 GbE form a group called “FlexE Group” and transmit the multiplexed frames converted to the Ethernet frames at a transmission rate of 100 (Gbps). As the client signals Sa to Sd, an optical channel transport unit (OTU) signal defined in international telecommunication union telecommunication standardization sector (ITU-T) recommendation G.709/Y.1331 is cited, for example. However, the client signals Sa to Sd are not limited thereto.

The signal demultiplexing device 2 demultiplexes the respective client signals Sa to Sd from the multiplexed frames and outputs the client signals Sa to Sd from the respective ports #1 to #4. At this time, the signal demultiplexing device 2 demultiplexes the client signals Sa to Sd and outputs the client signals Sa to Sd from the respective ports #1 to #4 based on a calendar notified from the signal multiplexing device 1 regarding each of the communication lines L1 and L2. As described later, the calendar indicates the port numbers that indicate ports of output destinations to which the client signals in the respective slots are output.

Plural slots are provided in the multiplexed frame and the signal multiplexing device 1 indicates the port number of the output destination of each slot in the multiplexed frame to the signal demultiplexing device 2 by the calendar. In the following description, ports #1 to #4 of the signal multiplexing device 1 will be represented as “input source ports” of the client signals Sa to Sd and ports #1 to #4 of the signal demultiplexing device 2 will be represented as “output destination ports” of the client signals Sa to Sd.

As above, the signal multiplexing device 1 may allow the client signals Sa to Sd at transmission rates that are not prescribed as a data rate of the Ethernet as an international standard to be flexibly accommodated in the Ethernet signals of 100 GbE and be transmitted.

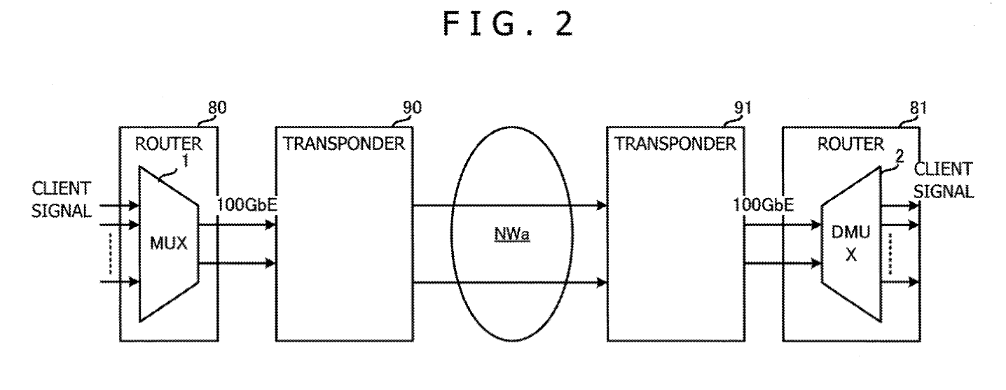

Next, application examples of the signal multiplexing device 1 and the signal demultiplexing device 2 will be described with reference to FIG. 2 to FIG. 4.

In an example of FIG. 2, the signal multiplexing device 1 is provided in a router 80 on the transmitting side and the signal demultiplexing device 2 is provided in a router 81 on the receiving side. In the present example and the following examples, the transmission direction is one direction from the router 80 on the transmitting side toward the router 81 on the receiving side for convenience of explanation. However, bidirectional transmission is enabled if the signal multiplexing device 1 is provided in the router 81 on the receiving side and the signal demultiplexing device 2 is provided in the router 80 on the transmitting side.

Transponders 90 and 91 that carry out wavelength division multiplexing transmission like a reconfigurable optical add and drop multiplexer (ROADM) are coupled to a network NWa. The router 80 on the transmitting side multiplexes client signals into multiplexed frames by the signal multiplexing device 1 and transmits the multiplexed frames to the transponder 90 through two communication lines of 100 GbE. The transponder 90 carries out wavelength multiplexing of the multiplexed frames with other signals and transmits the multiplexed frames as wavelength-multiplexed optical signals. At this time, the transponder 90 transmits the multiplexed frames to the other transponder 91 through the network NWa without terminating the multiplexed frames.

The transponder 91 receives the wavelength-multiplexed optical signals from the network NWa and acquires the multiplexed frames of the router 80 on the transmitting side from the wavelength-multiplexed optical signals. The transponder 91 transmits the multiplexed frames to the router 81 on the receiving side through two communication lines of 100 GbE. The router 81 on the receiving side demultiplexes the client signals from the multiplexed frames by the signal demultiplexing device 2 and outputs the client signals.

As above, in the present example, the transponders 90 and 91 and the network NWa relay communications between the signal multiplexing device 1 and the signal demultiplexing device 2.

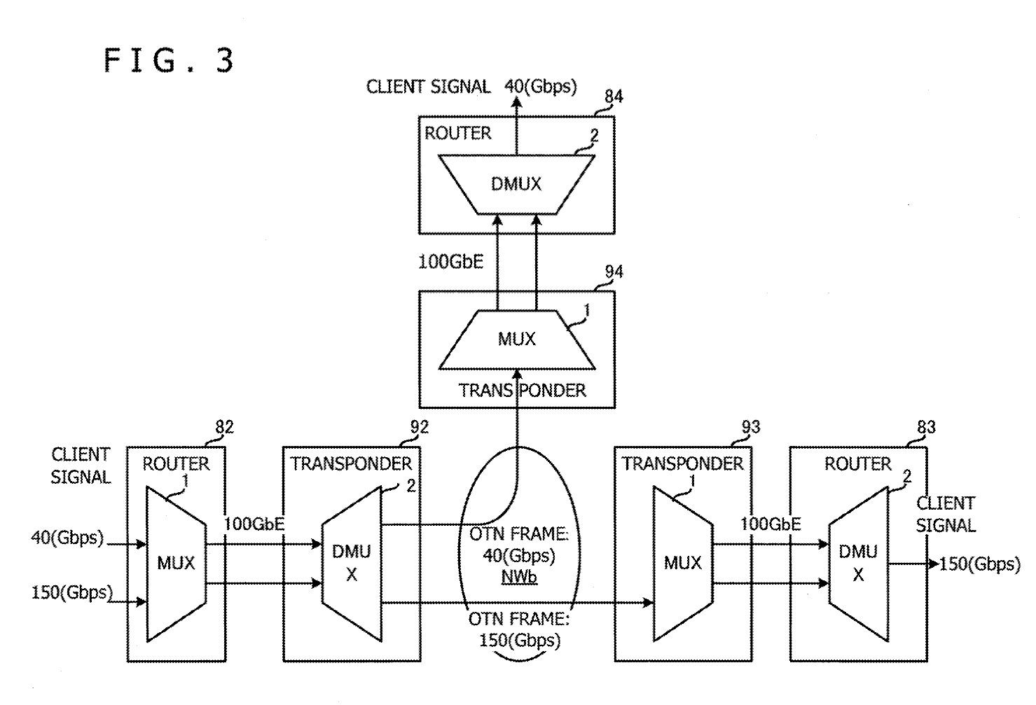

Furthermore, in an example of FIG. 3, the signal multiplexing device 1 is provided in a router 82 on the transmitting side and transponders 93 and 94 and the signal demultiplexing device 2 is provided in routers 83 and 84 on the receiving side and a transponder 92. In the present example, the case in which transmission is carried out only in the direction from the router 82 on the transmitting side toward the routers 83 and 84 on the receiving side is cited similarly to the example of FIG. 2.

To the router 82 on the transmitting side, the respective optical transport network (OTN) frames of 40 (Gbps) and 150 (Gbps) are input as client signals. The router 82 on the transmitting side multiplexes the client signals into multiplexed frames by the signal multiplexing device 1 and transmits the multiplexed frames to the transponder 92 through two communication lines of 100 GbE.

The transponder 92 demultiplexes the respective OTN frames of 40 (Gbps) and 150 (Gbps) as the client signals from the multiplexed frames by the signal demultiplexing device 2 and outputs the OTN frames to a network NWb. The OTN frame of 40 (Gbps) is input to the transponder 94 via the network NWb and the OTN frame of 150 (Gbps) is input to the transponder 93 via the network NWb.

The transponder 94 multiplexes the OTN frame of 40 (Gbps) into multiplexed frames by the signal multiplexing device 1 and transmits the multiplexed frames to the router 84 on the receiving side through two communication lines of 100 GbE. The router 84 on the receiving side demultiplexes the OTN frame of 40 (Gbps) as the client signal from the multiplexed frames by the signal demultiplexing device 2 and outputs the OTN frame.

The transponder 93 multiplexes the OTN frame of 150 (Gbps) into multiplexed frames by the signal multiplexing device 1 and transmits the multiplexed frames to the router 83 on the receiving side through two communication lines of 100 GbE. The router 83 on the receiving side demultiplexes the OTN frame of 150 (Gbps) as the client signal from the multiplexed frames by the signal demultiplexing device 2 and outputs the OTN frame.

As above, in the present example, the transponder 92 terminates the multiplexed frames and thereby the respective OTN frames of 40 (Gbps) and 150 (Gbps) demultiplexed from the multiplexed frames are output to the different transponders 94 and 93 via the network NWb.

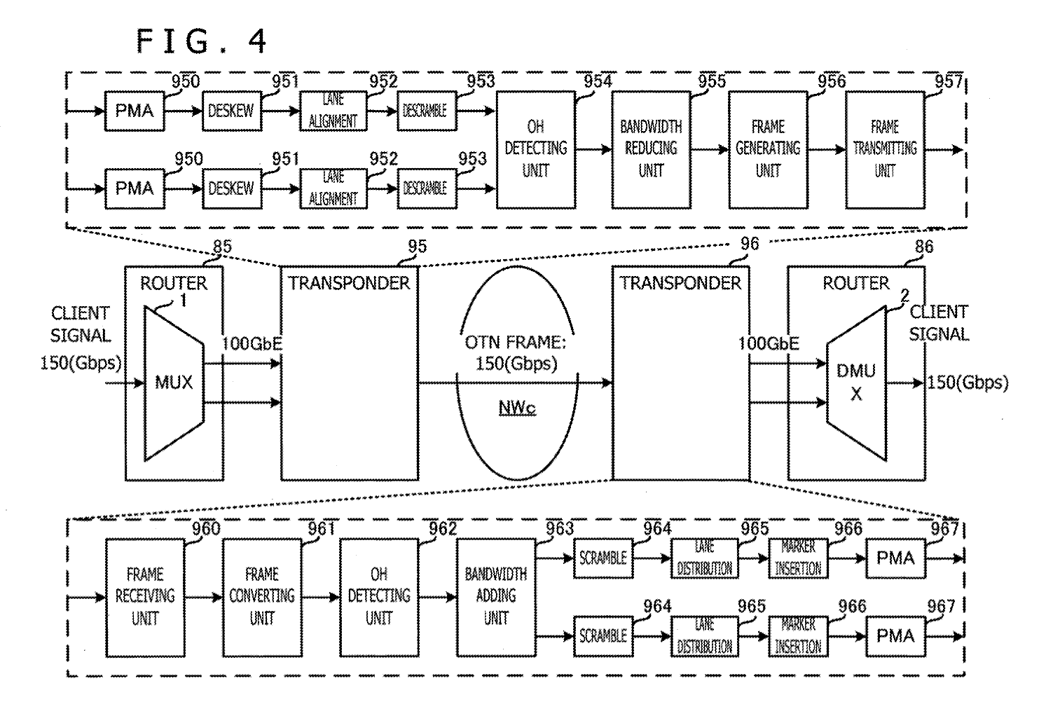

Furthermore, in an example of FIG. 4, the signal multiplexing device 1 is provided in a router 85 on the transmitting side and the signal demultiplexing device 2 is provided in a router 86 on the receiving side. It is to be noted that in the present example, the case in which transmission is carried out only in the direction from the router 85 on the transmitting side toward the router 86 on the receiving side is cited similarly to the example of FIG. 2.

Transponders 95 and 96 are coupled to a network NWc. An OTU frame of 150 (Gbps) is input to the router 85 on the transmitting side. The router 85 on the transmitting side multiplexes the OTU frame of 150 (Gbps) into multiplexed frames by the signal multiplexing device 1 and transmits the multiplexed frames to the transponder 95 through two communication lines of 100 GbE.

The transponder 95 does not terminate the multiplexed frames and deletes the difference in the communication bandwidth between the OTU frame of 150 (Gbps) and the communication lines of 100 GbE. As illustrated in a dotted line frame, the transponder 95 has physical medium attachment (PMA) function units 950, deskew units 951, lane alignment units 952, descrambling units 953, an overhead (OH) detecting unit 954, a bandwidth reducing unit 955, a frame generating unit 956, and a frame transmitting unit 957.

The PMA function unit 950, the deskew unit 951, the lane alignment unit 952, and the descrambling unit 953 are provided for each communication line of 100 GbE. The PMA function unit 950 carries out serial-parallel conversion of the signal of the OTU frame and outputs the signal to the deskew unit 951 through plural lanes. The deskew unit 951 executes deskew processing among pieces of data of the respective lanes by detecting an alignment marker that is a synchronization pattern inserted in the data of each lane. The deskewed data is input to the lane alignment unit 952.

The lane alignment unit 952 aligns each piece of data to the correct lane based on a lane number included in the alignment marker. The aligned data is input to the descrambling unit 953. The descrambling unit 953 descrambles the data and outputs the data to the OH detecting unit 954.

The OH detecting unit 954 detects a FlexE overhead from the data (multiplexed frames). The OH detecting unit 954 detects the difference in the communication bandwidth of the OTU frame with respect to the communication lines of 100 GbE from a calendar in the FlexE overhead and notifies the bandwidth reducing unit 955 of the difference. In the case of the present example, because the OTU frame of 150 (Gbps) is transmitted to the two communication lines of 100 GbE, communication bandwidth of 50 (Gbps) (=100×2−150) is detected as the difference. The FlexE overhead will be described later.

The bandwidth reducing unit 955 deletes slots equivalent to the difference in the communication bandwidth from the multiplexed frames and outputs the multiplexed frames to the frame generating unit 956. Then, the bandwidth reducing unit 955 cuts the surplus of the communication bandwidth of the multiplexed frames. It is to be noted that the frame generating unit 956 reconfigures the OTU frame of 150 (Gbps) from the multiplexed frames from which the surplus of the communication bandwidth has been cut and outputs the OTU frame to the frame transmitting unit 957.

The frame transmitting unit 957 includes a modulator, a laser diode, and so forth and transmits the OTU frame of 150 (Gbps) to the network NWc. Note that the above-described respective units 950 to 957 of the transponder 95 are configured as hardware such as a field programmable gate array (FPGA) and optical parts or functions of software that drives hardware and a processor such as a central processing unit (CPU).

The transponder 96 receives the OTU frame of 150 (Gbps) from the network NWc. As illustrated in a dotted line frame, the transponder 96 includes a frame receiving unit 960, a frame converting unit 961, an overhead (OH) detecting unit 962, a bandwidth adding unit 963, scrambling units 964, lane distribution units 965, marker inserting units 966, and PMA function units 967. The scrambling unit 964, the lane distribution unit 965, the marker inserting unit 966, and the PMA function unit 967 are provided for each communication line of 100 GbE.

The frame receiving unit 960 includes a photodiode and so forth and receives the OTU frame. The OTU frame is input to the frame converting unit 961. The frame converting unit 961 converts the OTU frame to an optical channel data unit (ODU) frame, for example. The ODU frame is input to the OH detecting unit 962.

The OH detecting unit 962 detects the FlexE overhead from the data (multiplexed frames) of the ODU frame. The OH detecting unit 962 detects the difference in the communication bandwidth of the OTU frame with respect to the communication lines of 100 GbE from a calendar in the FlexE overhead and notifies the bandwidth adding unit 963 of the difference. In the case of the present example, because the OTU frame of 150 (Gbps) is transmitted to the two communication lines of 100 GbE, communication bandwidth of 50 (Gbps) (=100×2−150) is detected as the difference.

The bandwidth adding unit 963 adds slots equivalent to the difference in the communication bandwidth to the multiplexed frames and outputs the multiplexed frames to the respective scrambling units 964. Then, the bandwidth adding unit 963 adds the surplus of the communication bandwidth of the multiplexed frames cut by the bandwidth reducing unit 955 to the multiplexed frames again.

The scrambling unit 964 scrambles the data of the multiplexed frame and outputs the data to the lane distribution unit 965. The lane distribution unit 965 distributes the data to plural lanes and outputs the data to the marker inserting unit 966. The marker inserting unit 966 inserts an alignment marker that is a synchronization pattern to the data of each lane and outputs the data to the PMA function unit 967.

The PMA function unit 967 carries out parallel-serial conversion of the data and transmits the data to the router 86 on the receiving side through the communication line of 100 GbE. Note that the above-described respective units 960 to 967 of the transponder 96 are configured as hardware such as an FPGA and optical parts or functions of software that drives hardware and a processor such as a CPU.

The router 86 on the receiving side demultiplexes the OTU frame of 150 (Gbps) as the client signal from the multiplexed frames by the signal demultiplexing device 2 and outputs the OTU frame.

As above, in the present example, the transponders 95 and 96 detect the difference in the communication bandwidth between the communication lines of 100 GbE and the client signal, and adjust the communication bandwidth of the OTN frame based on the difference. Thus, waste of the communication bandwidth of the network NWc may be cut.

Next, the multiplexing scheme of the signal multiplexing device 1 will be described.

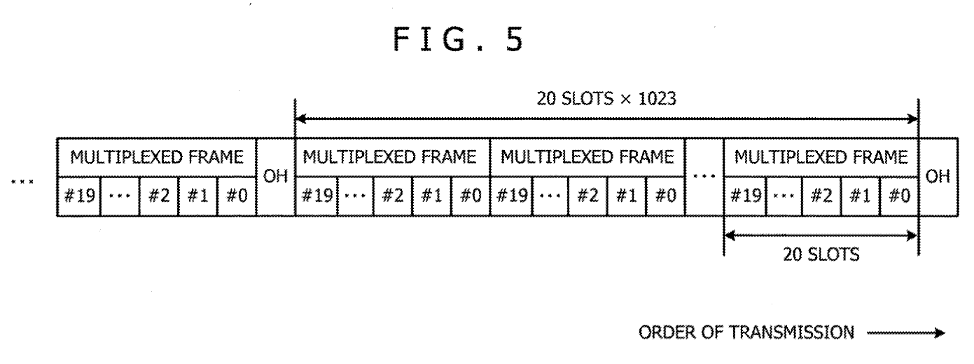

FIG. 5 is a configuration diagram illustrating one example of a multiplexed frame. In the respective communication lines L1 and L2, multiplexed frames each including 20 slots (#0, #1, . . . , #19) as one example and FlexE overheads (see “OH”) each inserted among 1023 multiplexed frames as one example are transmitted. The multiplexed frames and the FlexE overheads are sequentially transmitted in the right direction in the plane of paper of FIG. 5 (see “order of transmission”).

A client signal equivalent to, for example, 5 (Gbps) is accommodated in each slot. Thus, client signals of 100 (Gbps) (=5×20) may be accommodated in one multiplexed frame. As the data format in each slot, the 66B block is cited as one example. However, the data format is not limited thereto.

Furthermore, in the FlexE overhead, a calendar indicating the port number of the output destination port of the client signal in each slot is accommodated. This allows the signal demultiplexing device 2 to acquire the calendar from the FlexE overhead and demultiplex the client signals from the multiplexed frames to output the client signals to the output destination ports in accordance with the calendar.

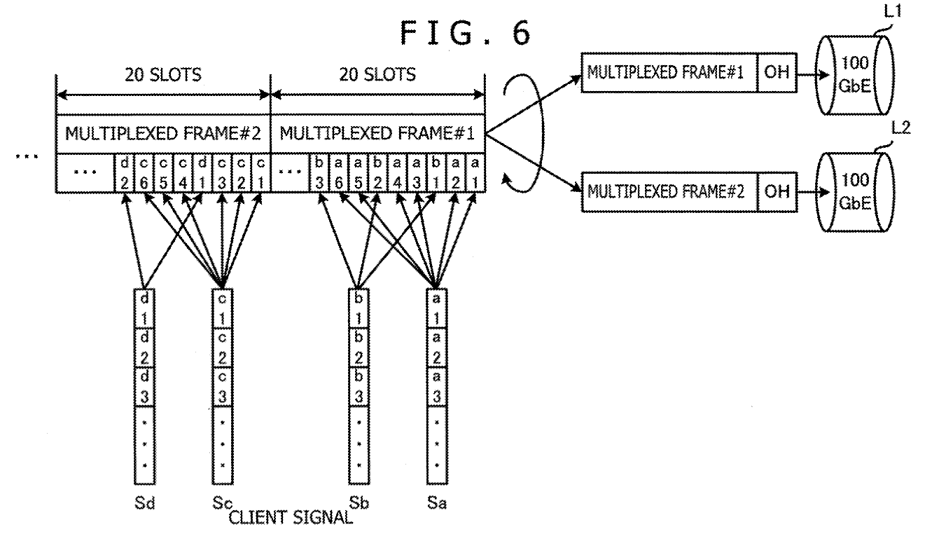

FIG. 6 is a diagram illustrating one example of multiplexing processing of client signals. It is to be noted that the client signals illustrated in FIG. 6 may be the client signals Sa to Sd illustrated in FIG. 1. In FIG. 6, 66B blocks a1, a2, a3, . . . are included in the client signal Sa and 66B blocks b1, b2, b3, . . . are included in the client signal Sb. Furthermore, 66B blocks c1, c2, c3, . . . are included in the client signal Sc and 66B blocks d1, d2, d3, . . . are included in the client signal Sd.

The signal multiplexing device 1 generates multiplexed frames #1 to be transmitted to the path P1 of the communication line L1 and multiplexed frames #2 to be transmitted to the path P2 of the communication line L2. In accordance with mapping information of the client signals Sa to Sd with respect to multiplexed frames #1 and #2, the signal multiplexing device 1 causes the 66B blocks of the client signals Sa and Sb to be accommodated in the respective slots of multiplexed frames #1 and causes the 66B blocks of the client signals Sc and Sd to be accommodated in the respective slots of multiplexed frames #2 as one example. Multiplexed frame #1 is one example of a first frame and multiplexed frame #2 is one example of a second frame.

The transmission rate of the client signal Sa is 50 (Gbps) and thus 66B blocks of the client signal Sa are accommodated in 10 slots of multiplexed frame #1. The transmission rate of the client signal Sb is 25 (Gbps) and thus 66B blocks of the client signal Sb are accommodated in five slots of multiplexed frame #1.

Furthermore, the transmission rate of the client signal Sc is 40 (Gbps) and thus 66B blocks of the client signal Sc are accommodated in eight slots of multiplexed frame #2. The transmission rate of the client signal Sd is 10 (Gbps) and thus 66B blocks of the client signal Sd are accommodated in two slots of multiplexed frame #2. Note that in the mapping of the client signals Sa to Sd, the signal multiplexing device 1 may cause 66B blocks to be accommodated in every other slot, for example, so that the use efficiency of the communication band of the communication lines L1 and L2 may be optimized.

The signal multiplexing device 1 alternately generates multiplexed frames #1 and #2 and causes the client signals Sa to Sd to be accommodated in multiplexed frames #1 and #2. Then, the signal multiplexing device 1 transmits each of multiplexed frames #1 and #2 through the communication lines L1 and L2 in accordance with a round-robin system. At this time, for each of the communication lines L1 and L2, the signal multiplexing device 1 inserts one FlexE overhead per 1023 multiplexed frames #1 or #2.

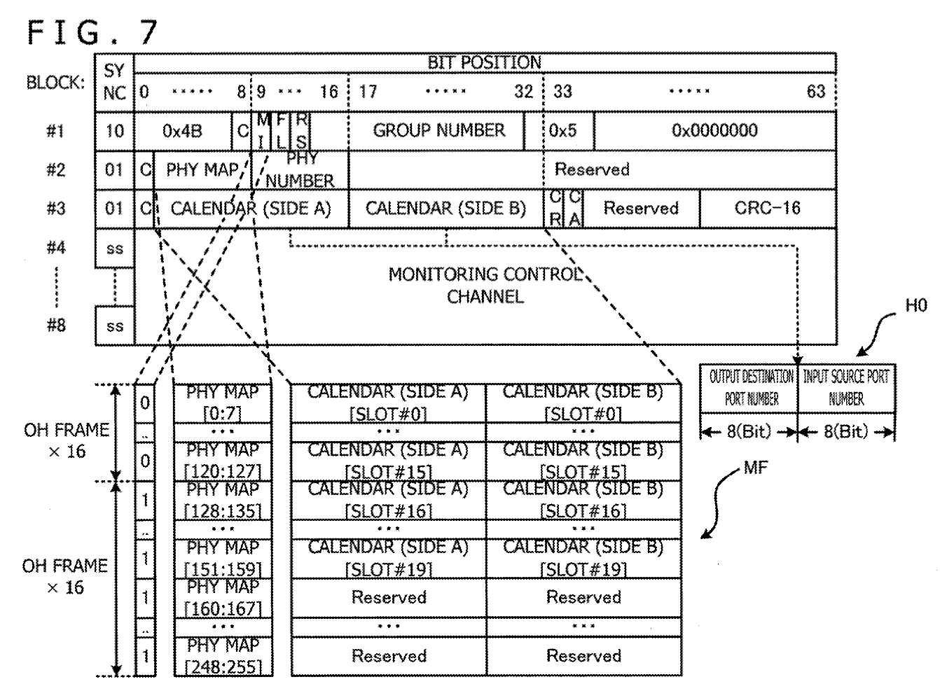

FIG. 7 is a diagram illustrating one example of a FlexE overhead. The FlexE overhead is an overhead frame based on “Flex Ethernet” and includes data of 66 (Bit) as with the 66B block. “Synchronization” indicates a synchronization header bit of 2 (Bit) in 66 (Bit). Furthermore, “bit position” indicates the positions of the remaining 64 (Bit). In the synchronization header bit represented by “ss,” an arbitrary pattern of 01 and 10 (binary digit) is inserted.

In the FlexE overhead, one overhead (OH) frame is configured by eight blocks #1 to #8. In block #1, 0x4B (0x denotes hexadecimal representation) as a fixed pattern, area “C,” area “MI,” area “FL,” area “RS,” “group number,” 0x5 as a fixed pattern, and 0x0000000 as a fixed pattern are included.

Area “C” is used for notification of switching between side A and side B of the calendar to the signal demultiplexing device 2. In area “MI,” an identifier of a multi-frame MF is set. Incidentally, area “FL” is used for notification of a fault in the communication line L1 or L2, for example. Area “RS” is a reserved area for extension. Areas “Reserved” described below are also reserved areas. “Group number” is the number of “FlexE Group.”

In block #2, area “C,” “PHY map,” “PHY number,” and area “Reserved” are included. Area “C” is as described above. “PHY map” indicates the communication lines L1 and L2 that belong to the same “FlexE Group.” “PHY number” is the identification number of the communication line L1 or L2 to which this FlexE overhead is transmitted.

In block #3, area “C,” “calendar (side A),” “calendar (side B),” area “CR,” area “CA,” area “Reserved,” and cyclic redundancy check (CRC)-16 are included. Area “C” is as described above. “Calendar (side A)” and “calendar (side B)” are calendar information composed of two sides and are used with switching according to the value of area “C.”

For example, if the value of area “C” is “0,” “calendar (side A)” is used as the calendar in use and “calendar (side B)” serves as the backup calendar. Furthermore, if the value of area “C” is “1,” “calendar (side B)” is used as the calendar in use and “calendar (side A)” serves as the backup calendar. Note that the calendar in use is the calendar used for mapping and demapping of client signals and the backup calendar is the calendar that is not used for mapping and demapping of client signals and is for reflecting the contents of change in the calendar in advance.

Therefore, in the case of changing the calendar, the signal multiplexing device 1 changes the contents of the backup calendar and then employs the calendar after the change as the calendar in use by switching the calendar in use based on the value of area “C.” Areas “C” at three places exist in one overhead frame. In the present example, it is assumed that switching between side A and side B is carried out when all of values of areas “C” at the three places are changed.

In each of “calendar (side A)” and “calendar (side B),” output destination port numbers of 8 (Bit) indicating the output destination ports and input source port numbers of 8 (Bit) indicating the input source ports are included as indicated by symbol H0. Incidentally, the output destination port numbers are port numbers #1 to #4 of the signal demultiplexing device 2 in FIG. 1 and the input source port numbers are port numbers #1 to #4 of the signal multiplexing device 1 in FIG. 1.

Area “CR” is used for notification of change in the calendar from the signal multiplexing device 1 to the signal demultiplexing device 2. If the value of area “CR” is “0,” this value indicates that change in the calendar does not exist. If the value of area “CR” is “1,” this value indicates that the calendar has been changed.

The signal demultiplexing device 2 detects change in the calendar based on the value of area “CR.” When detecting change in the calendar, the signal demultiplexing device 2 changes backup demapping information of client signals in this signal demultiplexing device 2 in advance based on the changed calendar to prepare for switching between “calendar (side A)” and “calendar (side B).” Then, the signal demultiplexing device 2 notifies the completion of preparation for switching by using area “CA” of a FlexE overhead addressed to the node of the signal multiplexing device 1 (in the opposite transmission direction).

For example, if the value of area “CA” is “0,” this value indicates that preparation for switching in the signal demultiplexing device 2 has not been completed. If the value of area “CA” is “1,” this value indicates that preparation for switching in the signal demultiplexing device 2 has been completed. It is to be noted that the signal demultiplexing device 2 notifies the signal multiplexing device 1 opposed to this signal demultiplexing device 2 of the completion of preparation for switching by using area “CA” of the FlexE overhead transmitted by the signal multiplexing device 1 of the same node as this signal demultiplexing device 2, for example.

Furthermore, CRC-16 is used for detection and correction of a data error in the other area in block #3.

Blocks #4 to #8 are used as a monitoring control channel between the signal multiplexing device 1 and the signal demultiplexing device 2. The signal multiplexing device 1 and the signal demultiplexing device 2 carry out monitoring control based on monitoring control information accommodated in the monitoring control channel.

The FlexE overhead multi-frame MF is composed of 32 overhead frames. The value of area “MI” of the former 16 overhead frames indicates “0” and the value of area “MI” of the latter 16 overhead frames indicates “1.” Furthermore, as “PHY map” of the respective overhead frames, “PHY map” of 256 (Bit) in total is represented in units of 8 (Bit).

Furthermore, “calendar (side A)” and “calendar (side B)” of the former 16 overhead frames correspond to slots #0 to #15 of multiplexed frame #1 or #2. “Calendar (side A)” and “calendar (side B)” of the first four overhead frames in the latter 16 overhead frames correspond to slots #16 to #19 of multiplexed frame #1 or #2. For example, “calendar (side A)” and “calendar (side B)” in the respective overhead frames indicate the output destination ports of the client signals Sa to Sd corresponding to slots #0 to #15 of multiplexed frame #1 or #2. Thus, mapping of slots #0 to #19 of multiplexed frames #1 and #2 is determined by “calendar (side A)” and “calendar (side B)” of the 20 overhead frames.

Next, the configuration of the signal multiplexing device 1 will be described.

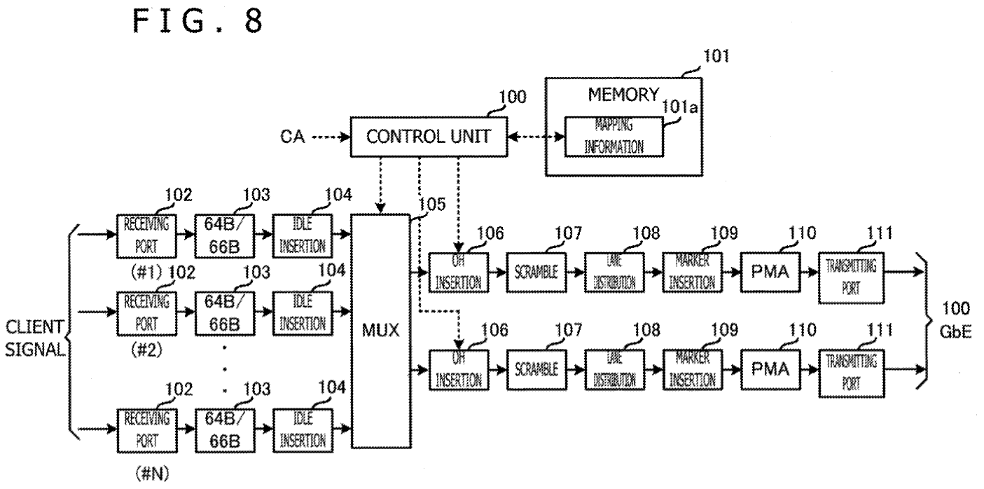

FIG. 8 is a configuration diagram illustrating one example of a signal multiplexing device. It is to be noted that the signal multiplexing device illustrated in FIG. 8 may be the signal multiplexing device 2 illustrated in FIG. 1. The signal multiplexing device 1 includes a control unit 100, a memory 101, plural receiving ports 102, plural 64B/66B conversion blocks 103, plural idle inserting units 104, and a multiplexing unit (MUX) 105. The signal multiplexing device 1 further includes an overhead (OH) inserting unit 106, a scrambling unit 107, a lane distribution unit 108, a marker inserting unit 109, a PMA function unit 110, and a transmitting port 111 for each of the communication lines L1 and L2.

The receiving port 102, the 64B/66B conversion block 103, and the idle inserting unit 104 are provided for each client signal. The receiving port 102 includes a photodiode and so forth and receives the client signal. The client signal is output from the receiving port 102 to the 64B/66B conversion block 103. The receiving ports 102 correspond to the above-described input source ports #1 to #N (N: positive integer).

The 64B/66B conversion block 103 carries out 64B/66B conversion of data of the client signal. Then, the data of the client signal is converted to 66B blocks. The 66B blocks are input to the idle inserting unit 104.

The idle inserting unit 104 inserts idle patterns between the 66B blocks. The idle patterns are inserted in a number according to the data amount so that space for the inter-frame gap, the FlexE overhead, and the alignment marker may be ensured in the data. The 66B blocks are input from the idle inserting unit 104 to the multiplexing unit 105.

The multiplexing unit 105 generates multiplexed frames in accordance with control by the control unit 100 and causes the 66B blocks to be accommodated in the respective slots #0 to #19 in the multiplexed frames. Then, the client signals are mapped into the multiplexed frames. The multiplexed frames that accommodate the 66B blocks are output to the OH inserting units 106.

The OH inserting units 106 insert FlexE overheads between the 66B blocks and between the multiplexed frames. The FlexE overheads are input from the control unit 100 to the OH inserting units 106.

The control unit 100 instructs the multiplexing unit 105 to carry out mapping in accordance with mapping information 101a stored in the memory 101. In the mapping information 101a, information relating to allocation of slots #0 to #19 according to the transmission rate of the client signal regarding each client signal and allocation of the port numbers of the output destination ports in the signal demultiplexing device 2 is included, for example.

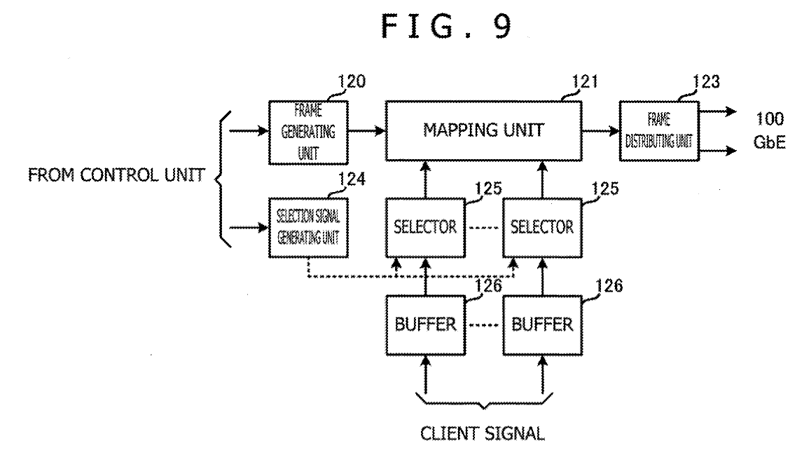

FIG. 9 is a configuration diagram illustrating one example of a multiplexing unit. It is to be noted that the multiplexing unit illustrated in FIG. 9 may be the multiplexing unit 105 illustrated in FIG. 8. The multiplexing unit 105 includes a frame generating unit 120, a mapping unit 121, a frame distributing unit 123, a selection signal generating unit 124, plural selectors 125, and plural buffers 126.

The frame generating unit 120 is one example of a generating unit and generates multiplexed frames #1 and #2 for the communication lines L1 and L2 in accordance with control from the control unit 100. Multiplexed frames #1 and #2 are input to the mapping unit 121. The mapping unit 121 holds multiplexed frames #1 and #2 and causes 66B blocks of the client signals input from the selectors 125 to be accommodated in multiplexed frames #1 and #2.

The selection signal generating unit 124 generates a selection signal to be output to each selector 125 in accordance with control from the control unit 100. In the selection signal, the number of multiplexed frame #1 or #2 as the accommodation destination of 66B blocks and the numbers of slots #0 to #19 are included regarding each client signal, for example.

The buffer 126 is provided for each client signal and stores 66B blocks of the client signal. As one example of the buffer 126, a first-in first-out (FIFO) buffer is cited, for example. However, the buffer 126 is not limited thereto. The 66B blocks stored in the buffer 126 are sequentially read out by the selector 125.

The selector 125 is provided for each client signal. The selector 125 selects the slots according to the selection signal among slots #0 to #19 of multiplexed frames #1 or multiplexed frames #2 in the mapping unit 121 and outputs 66B blocks to the slots. Then, the 66B blocks of the respective client signals are accommodated in slots #0 to #19 in multiplexed frames #1 and #2 as illustrated in FIG. 6.

For example, the selectors 125 and the mapping unit 121 are one example of an accommodation unit and cause each client signal to be accommodated in slots #0 to #19 of multiplexed frames #1 or multiplexed frames #2. Multiplexed frames #1 and #2 that accommodate the client signals are input to the frame distributing unit 123.

The frame distributing unit 123 distributes multiplexed frames #1 and #2 to the communication lines L1 and L2, respectively. For example, the frame distributing unit 123 outputs multiplexed frames #1 to the OH inserting unit 106 corresponding to the communication line L1 and outputs multiplexed frames #2 to the OH inserting unit 106 corresponding to the communication line L2.

Referring again to FIG. 8, based on the mapping information 101a, the control unit 100 generates FlexE overheads for each of the communication lines L1 and L2 and outputs the FlexE overheads to each OH inserting unit 106. For example, the control unit 100 generates a calendar from the mapping information 101a and inserts the calendar in “calendar (side A)” and “calendar (side B)” of the FlexE overheads.

Due to this, for example, if the accommodation destination of the client signal is slots #0 to #19 of multiplexed frames #1, the control unit 100 notifies the output destination port corresponding to these slots #0 to #19 to the signal demultiplexing device 2 through the path P1. This allows the signal demultiplexing device 2 to output the client signal demultiplexed from multiplexed frames #1 from this corresponding output destination port. Note that the control unit 100 is one example of a notifying unit.

Furthermore, in the case of changing the calendar, the control unit 100 controls area “CR” and area “C” in the FlexE overhead in a series of sequence as described later. In this sequence, the signal multiplexing device 1 receives area “CA” in the FlexE overhead in the opposite direction from the signal demultiplexing device 2 in the same node as this signal multiplexing device 1. The control unit 100 changes the calendar through change in the mapping information 101a.

The scrambling unit 107 executes scramble processing of 66B blocks input from the OH inserting unit 106. The 66B blocks subjected to the scramble processing are input to the lane distribution unit 108. The lane distribution unit 108 distributes the 66B blocks to plural lanes. The 66B blocks are input to the marker inserting unit 109 via the plural lanes.

The marker inserting unit 109 inserts the alignment marker between 66B blocks. The PMA function unit 110 carries out parallel-serial conversion of the 66B blocks input from the marker inserting unit 109 and outputs the 66B blocks to the transmitting port 111.

The transmitting ports 111 each include a modulator, a laser diode, and so forth and transmit the 66B blocks as Ethernet frames to the signal demultiplexing device 2 through the paths P1 and P2. For example, the transmitting port 111 corresponding to the communication line L1 is one example of a first transmitting unit and transmits multiplexed frames #1 to the signal demultiplexing device 2 through the path P1. Furthermore, the transmitting port 111 corresponding to the communication line L2 is one example of a second transmitting unit and transmits multiplexed frames #2 to the signal demultiplexing device 2 through the path P2. It is to be noted that the above-described respective units 100 to 111 of the signal multiplexing device 1 are configured as hardware such as an FPGA and optical parts or functions of software that drives hardware and a processor such as a CPU.

Next, the configuration of the signal demultiplexing device 2 will be described.

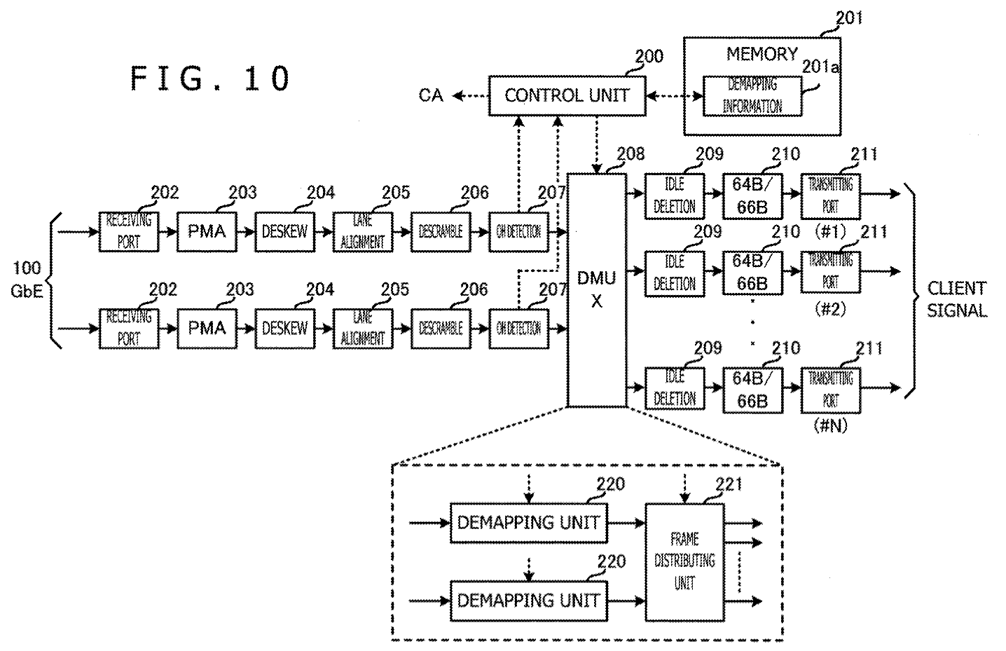

FIG. 10 is a configuration diagram illustrating one example of a signal demultiplexing device. It is to be noted that the signal demultiplexing device illustrated in FIG. 10 may be the signal demultiplexing device 2 illustrated in FIG. 1. The signal demultiplexing device 2 includes a receiving port 202, a PMA function unit 203, a deskew unit 204, a lane alignment unit 205, a descrambling unit 206, and an overhead (OH) detecting unit 207 for each of the communication lines L1 and L2. The signal demultiplexing device 2 further includes a control unit 200, a memory 201, a demultiplexing unit (DMUX) 208, plural idle deleting units 209, plural 64B/66B conversion units 210, and plural transmitting ports 211.

The receiving ports 202 each include a photodiode and so forth and receive Ethernet frames through the paths P1 and P2. For example, the receiving port 202 corresponding to the communication line L1 is one example of a first receiving unit and receives multiplexed frames #1 from the signal multiplexing device 1 through the path P1. Furthermore, the receiving port 202 corresponding to the communication line L2 is one example of a second receiving unit and receives multiplexed frames #2 from the signal multiplexing device 1 through the path P2. The 66B blocks of the Ethernet frames received by the receiving port 202 are input to the PMA function unit 203.

The PMA function unit 203 carries out serial-parallel conversion of the 66B blocks and outputs the 66B blocks to the deskew unit 204 through plural lanes. The deskew unit 204 executes deskew processing among the 66B blocks of the respective lanes by detecting an alignment marker inserted between 66B blocks of each lane. The deskewed 66B blocks are input to the lane alignment unit 205.

The lane alignment unit 205 aligns each 66B block to the correct lane based on a lane number included in the alignment marker. The aligned 66B blocks are input to the descrambling unit 206. The descrambling unit 206 descrambles the 66B blocks and outputs the 66B blocks to the OH detecting unit 207.

The OH detecting unit 207 detects the FlexE overhead from the 66B blocks. The OH detecting unit 207 detects the FlexE overhead based on a fixed pattern in the FlexE overhead, the cycle of the FlexE overhead, and so forth and outputs the FlexE overhead to the control unit 200.

The control unit 200 extracts “calendar (side A)” and “calendar (side B)” from block #3 of the FlexE overhead and generates demapping information 201a of the client signals from “calendar (side A)” and “calendar (side B).” In the demapping information 201a, regarding each of side A and side B, the output destination port numbers of the 66B blocks accommodated in the respective slots #0 to #19 of multiplexed frames #1 and #2 of the communication lines L1 and L2 are included. The control unit 200 makes the memory 201 store the demapping information 201a.

The OH detecting unit 207 outputs the 66B blocks excluding the FlexE overhead to the demultiplexing unit 208. The demultiplexing unit 208 includes a demapping unit 220 for each of the communication lines L1 and L2, and a frame distributing unit 221.

The demapping unit 220 corresponding to the communication line L1 acquires 66B blocks from multiplexed frames #1 in accordance with control from the control unit 200 and the demapping unit 220 corresponding to the communication line L2 acquires 66B blocks from multiplexed frames #2 in accordance with control from the control unit 200. For example, based on the demapping information 201a, the control unit 200 indicates, to the demultiplexing unit 208, the slots in which 66B blocks are accommodated among slots #0 to #19 of multiplexed frames #1 and #2.

At this time, information corresponding to both of “calendar (side A)” and “calendar (side B)” is included in the demapping information 201a. However, the control unit 200 selects information corresponding to the calendar in use from side A and side B and carries out the indication based on the selected information.

For this reason, the demapping unit 220 does not execute acquisition processing of 66B blocks from slots in which a 66B block is not accommodated. Incidentally, The value of the calendar corresponding to the slot in which a 66B block is not accommodated is 0x0000 (unused) or 0xFFFF (unusable), for example. The demapping unit 220 outputs the acquired 66B blocks to the frame distributing unit 221.

The frame distributing unit 221 distributes the 66B blocks to the respective idle deleting units 209 in accordance with an instruction from the control unit 200. Based on the demapping information 201a, the control unit 200 indicates the output destination port number to the frame distributing unit 221 regarding each of slots #0 to #19 of multiplexed frames #1 and #2. The frame distributing unit 221 outputs 66B blocks to the idle deleting unit 209 according to the output destination port number. For example, if the output destination port number is #1, the 66B blocks are output to the idle deleting unit 209 corresponding to the transmitting port (#1) 211.

As above, the FlexE overhead functions as notification of the output destination port of the client signal regarding each of slots #0 to #19 from the signal multiplexing device 1 to the signal demultiplexing device 2. For example, if the accommodation destinations of 66B blocks of client signals are slots #0 to #19 of multiplexed frames #1, the control unit 200 receives notification of the output destination ports (transmitting ports 211) of the 66B blocks in these slots from the signal multiplexing device 1 through the path P1. Furthermore, in accordance with the notification, the demapping unit 220 acquires the 66B blocks from multiplexed frames #1 and outputs the 66B blocks from the output destination ports. It is to be noted that the control unit 200 and the demultiplexing unit 208 function as an acquiring unit that acquires the client signals from multiplexed frames #1 or multiplexed frames #2.

Furthermore, if the calendar is changed, the control unit 200 operates based on area “CR” and area “C” in the FlexE overhead in the series of sequence as described later. In this sequence, the signal demultiplexing device 2 controls area “CA” in the FlexE overhead in the opposite direction transmitted by the signal multiplexing device 1 in the same node as this signal demultiplexing device 2. The control unit 200 changes the demapping information 201a in association with the change in the calendar information.

The idle deleting unit 209 deletes the idle pattern between 66B blocks. The 66B blocks from which the idle pattern has been deleted are input to the 64B/66B conversion unit 210. The 64B/66B conversion unit 210 converts the 66B blocks to 64B blocks and outputs the 64B blocks to the transmitting port 211.

The transmitting port 211 includes a modulator, a laser diode, and so forth and transmits the 64B blocks as the client signal. The transmitting ports 211 are each one example of a port and are equivalent to output destination ports #1 to #N. It is to be noted that the above-described respective units 200 to 211 of the signal demultiplexing device 2 are configured as hardware such as an FPGA and optical parts or functions of software that drives hardware and a processor such as a CPU.

Next, change in the calendar will be described. First, an example in which a client signal is deleted will be cited.

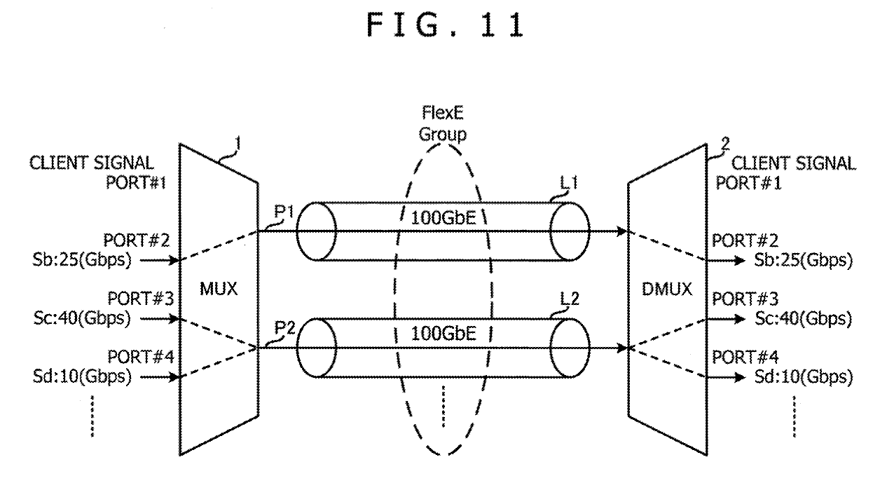

FIG. 11 is a diagram illustrating one example of deletion of a client signal. It is to be noted that the client signal illustrated in FIG. 11 may be the client signal Sa illustrated in FIG. 1. In FIG. 11, the configuration common with FIG. 1 is given the same symbol and description thereof is omitted.

In the present example, the case of deleting the client signal Sa among the client signals Sa to Sd in FIG. 1 will be cited. If the client signal Sa is deleted, only the client signal Sb is transmitted to the communication line L1.

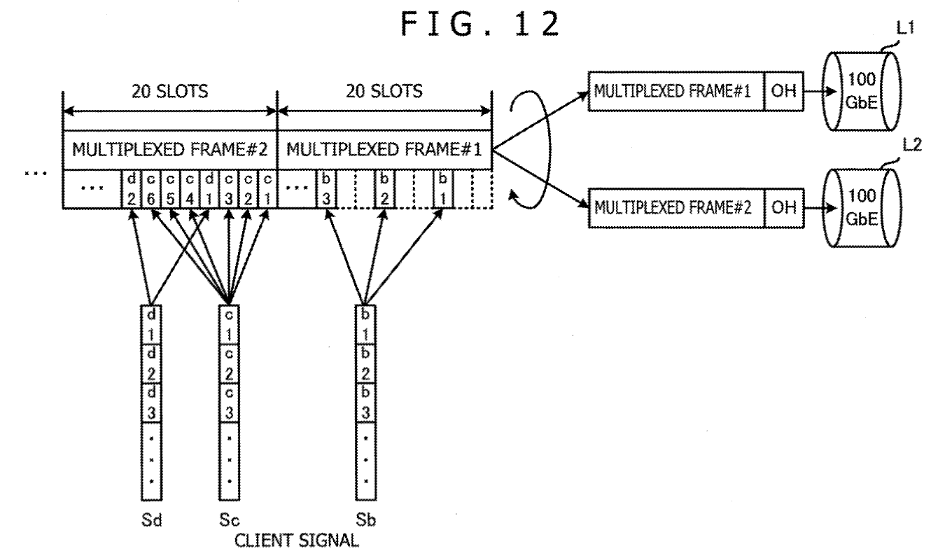

FIG. 12 is a diagram illustrating one example of multiplexing processing after a deletion of a client signal. It is to be noted that the client signal illustrated in FIG. 12 may be the client signal Sa illustrated in FIG. 1. In FIG. 12, description is omitted regarding contents common with FIG. 6.

In slots #0 to #19 of multiplexed frames #1 of the communication line L1, the slots in which the deleted client signal Sa has been accommodated become empty slots (see dotted lines). Thus, only the client signal Sb is accommodated in multiplexed frames #1.

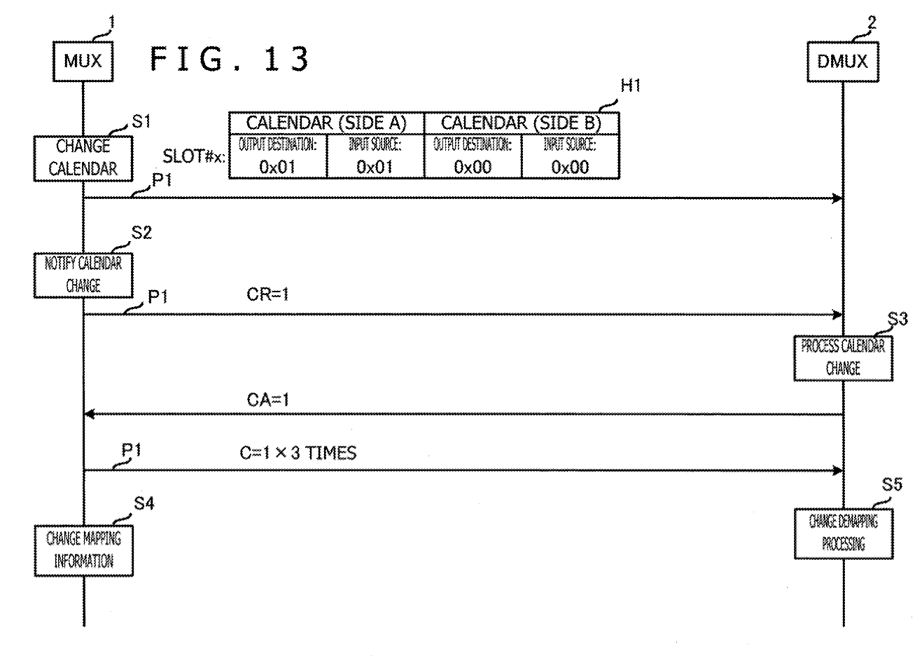

FIG. 13 is a sequence diagram illustrating one example of deletion processing of a client signal. It is to be noted that the client signal illustrated in FIG. 13 may be the client signal Sa illustrated in FIG. 1. In the present example, the calendar of side A is employed as the calendar in use and the calendar of side B is employed as the backup calendar. Furthermore, suppose that the client signal Sa is accommodated in slots #x (x: ten integers in 0, 1, . . . , 19) of multiplexed frames #1 before being deleted in the present example.

In the signal multiplexing device 1, the control unit 100 changes “calendar (side B)” of slots #x as the accommodation destination of the client signal Sa regarding the FlexE overhead (block #3) of the communication line L1 (operation S1). For example, the control unit 100 sets the value of “calendar (side B)” of slots #x to 0x0000 (unused).

The control unit 100 transmits the FlexE overhead in which “calendar (side B)” has been changed to the signal demultiplexing device 2 through the path P1. Symbol H1 represents the contents of “calendar (side A)” and “calendar (side B)” of the FlexE overhead.

The output destination port number and the input source port number of “calendar (side B)” are each 0x00 (unused). Furthermore, because the client signal Sa is output from input source port #1 of the signal multiplexing device 1 to output destination port #1 of the signal demultiplexing device 2, the output destination port number and the input source port number of “calendar (side A)” are each 0x01 (#1).

The control unit 200 of the signal demultiplexing device 2 receives the FlexE overhead in which “calendar (side B)” has been changed. However, the control unit 200 does not detect the change in the calendar because the value of area “CR” of the FlexE overhead is “0.”

Next, in the signal multiplexing device 1, the control unit 100 notifies the signal demultiplexing device 2 of the change in the calendar by changing the value of area “CR” of the FlexE overhead (block #3) from “0” to “1” (operation S2). The control unit 100 transmits the FlexE overhead in which the value of area “CR” is “1” to the signal demultiplexing device 2 through the path P1.

In the signal demultiplexing device 2, the control unit 200 receives the FlexE overhead in which the value of area “CR” is “1.” Because the value of area “CR” is “1,” the control unit 200 detects the change in “calendar (side B)” and changes the calendar of side B (operation S3). For example, the control unit 200 sets slots #x as the accommodation destination of the client signal Sa to empty slots regarding the communication line L1 in the demapping information 201a corresponding to the calendar of side B as the backup. Then, the signal demultiplexing device 2 completes preparation for switching of the calendar for deleting the client signal Sa.

Next, the control unit 200 transmits a FlexE overhead in which the value of area “CA” is “1” to the signal multiplexing device 1 (as the communication counterpart) by a signal multiplexing device of the same node as the signal demultiplexing device 2 of this control unit 200 (signal multiplexing device different from the signal multiplexing device 1 as the communication counterpart). Then, the signal demultiplexing device 2 notifies the signal multiplexing device 1 of the completion of preparation for switching of the calendar for deleting the client signal Sa.

In the signal multiplexing device 1, the control unit 100 receives the FlexE overhead in which the value of area “CA” is “1.” Then, the control unit 100 detects the completion of preparation for switching of the calendar in the signal demultiplexing device 2.

Next, the control unit 100 transmits three FlexE overheads in which the value of area “C” has been changed from “0” to “1” (blocks #1 to #3) to the signal demultiplexing device 2 through the path P1. Then, the control unit 100 instructs the signal demultiplexing device 2 to set the calendar in use to the calendar of side B.

Next, the control unit 100 changes the mapping information 101a based on the calendar of side B after the change (operation S4). For example, the control unit 100 sets slots #x of multiplexed frames #1 to unused slots in the mapping information 101a. Due to this, the mapping unit 121 stops accommodation of the client signal Sa in slots #x of multiplexed frames #1.

Furthermore, in the signal demultiplexing device 2, the control unit 200 receives the three FlexE overheads in which the value of area “C” is “1.” Then, the control unit 200 receives the instruction to delete the client signal Sa from the signal multiplexing device 1.

Next, the control unit 200 changes demapping processing of the demapping unit 220 for the communication line L1 by switching the calendar in use from the calendar of side A to the calendar of side B (operation S5). For example, the control unit 200 controls the demapping unit 220 based on the demapping information 201a corresponding to the calendar of side B. Due to this, the demapping unit 220 stops acquisition of the client signal Sa from slots #x of multiplexed frames #1.

As above, in the case of deleting the client signal Sa from multiplexed frames #1, the control unit 100 of the signal multiplexing device 1 notifies slots #x of the client signal Sa as the deletion target to the control unit 200 of the signal demultiplexing device 2 before the deletion. For this reason, the signal multiplexing device 1 and the signal demultiplexing device 2 may synchronize the timings of the deletion of the client signal Sa. Therefore, the signal multiplexing device 1 and the signal demultiplexing device 2 may reduce the error that occurs due to the deletion of the client signal Sa.

Referring again to FIG. 11, after the deletion of the client signal Sa, only the client signal Sb is accommodated in the communication line L1 and thus only communication bandwidth corresponding to 25 (Gbps) is used in the communication bandwidth of the communication line L1. On the other hand, the client signals Sc and Sd are accommodated in the communication line L2 and thus only communication bandwidth corresponding to 50 (Gbps) (=40+10) is used in the communication bandwidth of the communication line L2. Thus, the surplus of the communication bandwidth of the communication line L1 is 75 (Gbps) (=100−25) and the surplus of the communication bandwidth of the communication line L2 is 50 (Gbps) (=100−50).

Therefore, the total of the surplus of the communication lines L1 and L2 is 125 (Gbps) (=75+50) and surpasses the communication bandwidth of one communication line L1 or L2. Thus, the use efficiency of the communication bandwidth is low. Accordingly, for example, it is conceivable that the client signal Sb is accommodated in the communication line L2 by switching the path of the client signal Sb from the path P1 to the path P2.

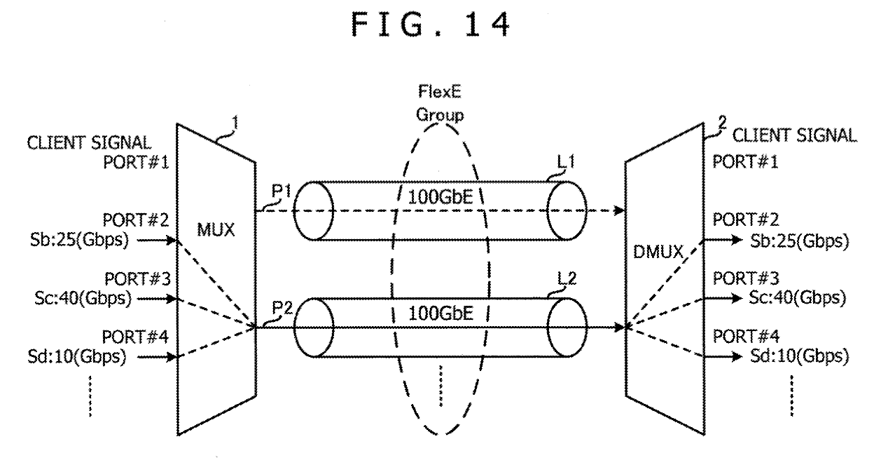

FIG. 14 is a diagram illustrating one example of path switching of a client signal. It is to be noted that the client signal illustrated in FIG. 14 may be the client signal Sb illustrated in FIG. 1. In FIG. 14, the configuration common with FIG. 1 is given the same symbol and description thereof is omitted.

In the present example, the client signals Sb and Sc are accommodated in the communication line L2 and a client signal accommodated in the communication line L1 does not exist. Thus, the used communication bandwidth of the communication line L2 is 75 (Gbps) (=25+40+10) and the use efficiency of the communication bandwidth of the communication line L2 is improved relative to the example of FIG. 11.

On the other hand, the used communication bandwidth of the communication line L1 is 0 (Gbps). However, for example, in the case of newly adding a client signal of 100 (Gbps), the client signal may be accommodated in the communication line L1 and thus the communication bandwidth of the communication line L1 may be efficiently utilized.

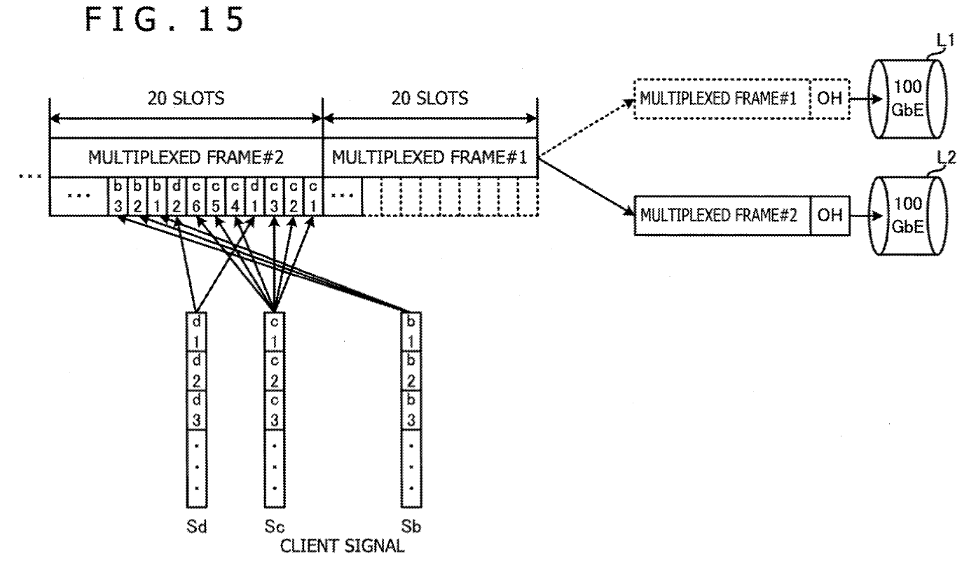

FIG. 15 is a diagram illustrating one example of multiplexing processing after a path switching of a client signal. It is to be noted that the client signal illustrated in FIG. 15 may be the client signal Sb illustrated in FIG. 1. In FIG. 15, description is omitted regarding contents common with FIG. 6.

Data of the client signals Sb to Sd is accommodated in the communication line L2 and is transmitted. On the other hand, a client signal accommodated in the communication line L1 does not exist (see dotted lines). Thus, the signal multiplexing device 1 does not need to transmit multiplexed frames #1 through the communication line L1. Therefore, the signal multiplexing device 1 may reduce the power consumption by setting the functional units relating to the transmission by the communication line L1 to the sleep state.

However, in this case, the path of the client signal Sb that is being transmitted is switched and thus possibly an error occurs due to the influence of the path switching on the other client signals Sc and Sd, for example. Then, the signal multiplexing device 1 and the signal demultiplexing device 2 carry out a sequence similar to the sequence illustrated in FIG. 13 to reduce the error.

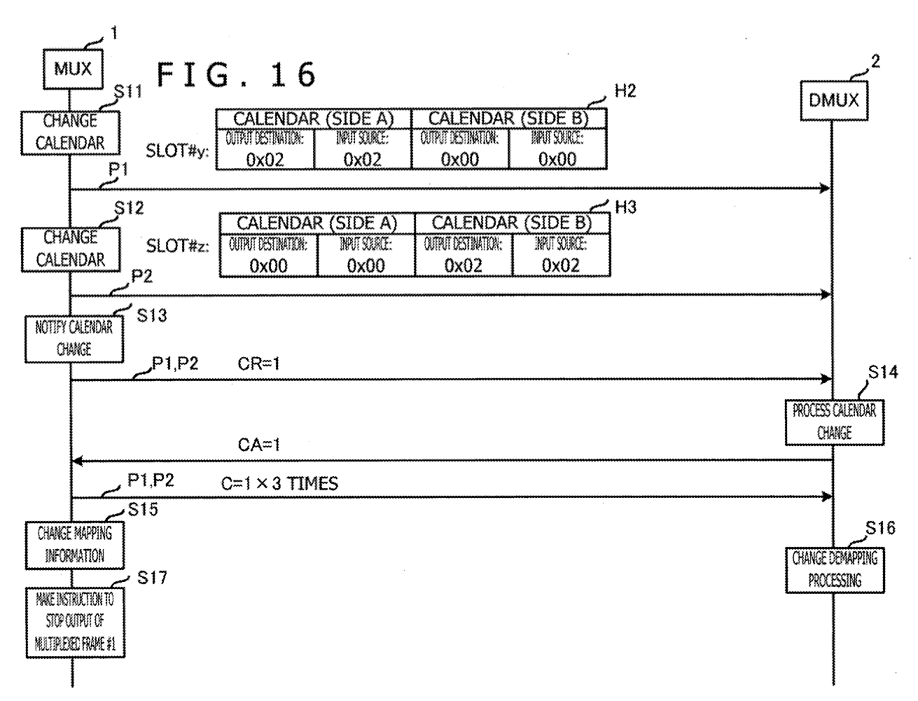

FIG. 16 is a sequence diagram illustrating one example of path switching processing of a client signal. It is to be noted that the client signal illustrated in FIG. 16 may be the client signal Sb illustrated in FIG. 1. In the present example, the calendar of side A is employed as the calendar in use and the calendar of side B is employed as the backup calendar. Furthermore, in the present example, the case of switching the accommodation destination of the client signal Sb from slots #y (y: five integers in 0, 1, . . . , 19) of multiplexed frames #1 to slots #z (z: five integers in 0, 1, . . . , 19) of multiplexed frames #2 is cited.

In the signal multiplexing device 1, the control unit 100 changes “calendar (side B)” of slots #y as the accommodation destination of the client signal Sb regarding the FlexE overhead (block #3) of one communication line L1. (operation S11). For example, the control unit 100 sets the value of “calendar (side B)” of slots #y to 0x0000 (unused).

The control unit 100 transmits the FlexE overhead in which “calendar (side B)” has been changed to the signal demultiplexing device 2 through the path P1. Symbol H2 represents the contents of “calendar (side A)” and “calendar (side B)” of the FlexE overhead.

The output destination port number and the input source port number of “calendar (side B)” are each 0x00 (unused). Furthermore, because the client signal Sb is output from input source port #2 of the signal multiplexing device 1 to output destination port #2 of the signal demultiplexing device 2, the output destination port number and the input source port number of “calendar (side A)” are each 0x02 (#2).

As above, if the accommodation destination of the client signal Sb is slots #y of multiplexed frames #1, the control unit 100 notifies the output destination port of the client signal in slots #y to the signal demultiplexing device 2 through the path P1. This allows the demapping unit 220 of the signal demultiplexing device 2 to acquire the client signal Sb from slots #y of multiplexed frames #1 to output the client signal Sb from the output destination port.

For example, if the accommodation destination of the client signal Sb is slots #y of multiplexed frames #1, the control unit 200 of the signal demultiplexing device 2 receives the notification of the output destination port of the client signal Sb in slots #y from the signal multiplexing device 1 through the path P1. The demapping unit 220 acquires the client signal Sb from slots #y of multiplexed frames #1 to output the client signal Sb from the output destination port in accordance with the notification.

Furthermore, the control unit 200 of the signal demultiplexing device 2 receives the FlexE overhead in which “calendar (side B)” has been changed through the path P1. However, the control unit 200 does not detect the change in the calendar because the value of area “CR” of the FlexE overhead is “0.”

Next, the control unit 100 changes “calendar (side B)” of slots #z (z: positive integers) as the accommodation destination of the client signal Sb after the change regarding the FlexE overhead (block #3) of the other communication line L2 (operation S12). For example, the control unit 100 sets the value of “calendar (side B)” of slots #z to 0x02. Incidentally, suppose that slots #z are unused slots.

The control unit 100 transmits the FlexE overhead in which “calendar (side B)” has been changed to the signal demultiplexing device 2 through the path P2. Symbol H3 represents the contents of “calendar (side A)” and “calendar (side B)” of the FlexE overhead.

Because the client signal Sb is output from input source port #2 of the signal multiplexing device 1 to output destination port #2 of the signal demultiplexing device 2, the output destination port number and the input source port number of “calendar (side B)” are each 0x02 (#2). Furthermore, because slots #z are unused, the output destination port number and the input source port number of “calendar (side A)” are each 0x00 (unused).

The control unit 200 of the signal demultiplexing device 2 receives the FlexE overhead in which “calendar (side B)” has been changed through the path P2. However, the control unit 200 does not detect the change in the calendar because the value of area “CR” of the FlexE overhead is “0.”

Next, in the signal multiplexing device 1, the control unit 100 notifies the signal demultiplexing device 2 of the change in the calendar by changing the value of area “CR” of the respective FlexE overheads (block #3) of the communication lines L1 and L2 (operation S13). The control unit 100 transmits the FlexE overheads in which the value of area “CR” is “1” to the signal demultiplexing device 2 through the paths P1 and P2.

In the signal demultiplexing device 2, the control unit 200 receives the FlexE overheads in which the value of area “CR” is “1” through the paths P1 and P2. Because the value of area “CR” is “1,” the control unit 200 detects the change in “calendar (side B)” and changes the calendar of side B (operation S14). For example, the control unit 200 sets slots #y as the accommodation destination of the client signal Sb to empty slots regarding one communication line L1 in the demapping information 201a corresponding to the calendar of side B as the backup.

Furthermore, the control unit 200 sets slots #z of multiplexed frames #2 to the new accommodation destination of the client signal Sb regarding the other communication line L2 in the demapping information 201a corresponding to the calendar of side B as the backup. For example, regarding the demapping information 201a, the control unit 200 sets the output destination port of the client signal Sb accommodated in slots #z of multiplexed frames #2.

Then, the signal demultiplexing device 2 completes preparation for switching of the calendar for path switching of the client signal Sb.

Next, the control unit 200 transmits a FlexE overhead in which the value of area “CA” is “1” to the signal multiplexing device 1 (as the communication counterpart) by a signal multiplexing device of the same node as the signal demultiplexing device 2 of this control unit 200 (signal multiplexing device different from the signal multiplexing device 1 as the communication counterpart). Then, the signal demultiplexing device 2 notifies the signal multiplexing device 1 of the completion of preparation for switching of the calendar for path switching of the client signal Sb.

In the signal multiplexing device 1, the control unit 100 receives the FlexE overhead in which the value of area “CA” is “1.” Then, the control unit 100 detects the completion of preparation for switching of the calendar in the signal demultiplexing device 2.

Next, the control unit 100 transmits three FlexE overheads in which the value of area “C” has been changed from “0” to “1” (blocks #1 to #3) to the signal demultiplexing device 2 through the paths P1 and P2. Then, the control unit 100 instructs the signal demultiplexing device 2 to set the calendar in use to the calendar of side B regarding both of the communication lines L1 and L2.

Next, regarding both of the communication lines L1 and L2, the control unit 100 changes the mapping information 101a based on the calendar of side B after the change (operation S15). For example, the control unit 100 sets the respective slots #y of multiplexed frames #1 to unused slots regarding one communication line L1 in the mapping information 101a. Due to this, the mapping unit 121 stops accommodation of the client signal Sb in the respective slots #y of multiplexed frames #1.

Furthermore, the control unit 100 sets the accommodation subject of slots #z of multiplexed frames #2 to the client signal Sb regarding the other communication line L2 in the mapping information 101a. Due to this, the mapping unit 121 causes the client signal Sb to be accommodated in slots #z of multiplexed frames #2.

Moreover, in the signal demultiplexing device 2, the control unit 200 receives the three FlexE overheads in which the value of area “C” is “1” through the paths P1 and P2. Then, the control unit 200 receives the instruction to switch the path of the client signal Sb from the signal multiplexing device 1.

Next, the control unit 200 changes demapping processing of the demapping unit 220 for the communication lines L1 and L2 by switching the calendar in use from the calendar of side A to the calendar of side B regarding both of the communication lines L1 and L2 (operation S16). For example, the control unit 200 controls the demapping unit 220 based on the demapping information 201a corresponding to the calendar of side B. Due to this, the demapping unit 220 stops acquisition of the client signal Sb from the respective slots #y of multiplexed frames #1 and starts acquisition of the client signal Sb from slots #z of multiplexed frames #2.

Furthermore, in the signal multiplexing device 1, the control unit 100 detects that another client signal accommodated in slots of multiplexed frames #1 does not exist, and instructs the frame generating unit 120 to stop generation and output of multiplexed frames #1 (operation S17). Thus, the transmitting port 111 of the communication line L1 stops transmission of multiplexed frames #1. Due to this, the transmitting port 111 of the communication line L1 is controlled to the sleep state in accordance with control by the control unit 100.

As above, if another client signal accommodated in slots of multiplexed frames #1 does not exist, the transmitting port 111 of the communication line L1 stops transmission of multiplexed frames #1. Thus, the power consumption of the signal multiplexing device 1 may be reduced.

In the sequence of the present example, the control unit 100 of the signal multiplexing device 1 reflects the change in the accommodation destination of the client signal Sb in “calendar (side B)” of the FlexE overhead of the communication line L2 (operation S12), and notifies the signal demultiplexing device 2 of the change by area “CR” (operation S13). Thereafter, the control unit 100 changes the mapping information 101a according to the change in the accommodation destination of the client signal Sb (operation S15).

For example, in the case of switching the accommodation destination of the client signal Sb from slots #y of multiplexed frames #1 to slots #z of multiplexed frames #2, the control unit 100 notifies the signal demultiplexing device 2 of the correspondence relationship between slots #z of multiplexed frames #2 and output destination port #2 through the path P2 before the switching.

Meanwhile, before the signal multiplexing device 1 changes the accommodation destination of the client signal Sb (operation S15), the control unit 200 of the signal demultiplexing device 2 receives notification of the change from the signal multiplexing device 1 based on “calendar (side B)” and area “CR” of the FlexE overhead of the communication line L2 (operations S12 and S13).

For example, in the case of switching the accommodation destination of the client signal Sb from slots #y of multiplexed frames #1 to slots #z of multiplexed frames #2, the control unit 200 receives notification of the correspondence relationship between slots #z of multiplexed frames #2 and output destination port #2 from the signal multiplexing device 1 through the path P2 before the switching.

For this reason, before the signal multiplexing device 1 changes the accommodation destination of the client signal Sb, the signal demultiplexing device 2 may recognize the change. Therefore, prior to the change in the accommodation destination of the client signal Sb, the signal demultiplexing device 2 may make preparations for the change, such as reflecting the change in the demapping information 201a. This allows the signal multiplexing device 1 and the signal demultiplexing device 2 to reduce the error that occurs due to the path switching.

Furthermore, in the sequence of the present example, the control unit 100 of the signal multiplexing device 1 generates a FlexE overhead regarding each of the paths P1 and P2 and carries out notification to the signal demultiplexing device 2 by the FlexE overheads. This allows the signal multiplexing device 1 to carry out frame transmission based on the “Flex Ethernet” technique and achieve advantages relating to the above-described multiplexing.

Moreover, the control unit 100 carries out notification to the signal demultiplexing device 2 by “calendar (side A)” and “calendar (side B).” This allows the control unit 100 to easily notify the signal demultiplexing device 2 of output destination ports based on the mapping information 101a.

In the present embodiment, the multiplexing unit 105 of the signal multiplexing device 1 may select the accommodation destination of the client signal Sb from all slots #0 to #19 of multiplexed frames #1 or multiplexed frames #2 by the selectors 125. However, because the number of slots as the selection target of the selectors 125 is large, possibly the circuit scale of the selectors 125 becomes large. For example, if plural pairs of client signals at the same transmission rate in the relationship between the in-use system and the backup system are input to the signal multiplexing device 1, the number of selectors 125 increases and thus the circuit scale of the whole of the multiplexing unit 105 increases.

Then, the selectors 125 may select the slot of the accommodation destination from slots according to the transmission rate of the client signal among slots #0 to #19 of multiplexed frames #1 or multiplexed frames #2. For example, the slots of multiplexed frames #1 and #2 may be fixed on each transmission rate basis. In this case, the number of slots as the selection target of the selectors 125 is reduced according to the transmission rates of the client signals and thus the circuit scale of the selectors 125 may be reduced.

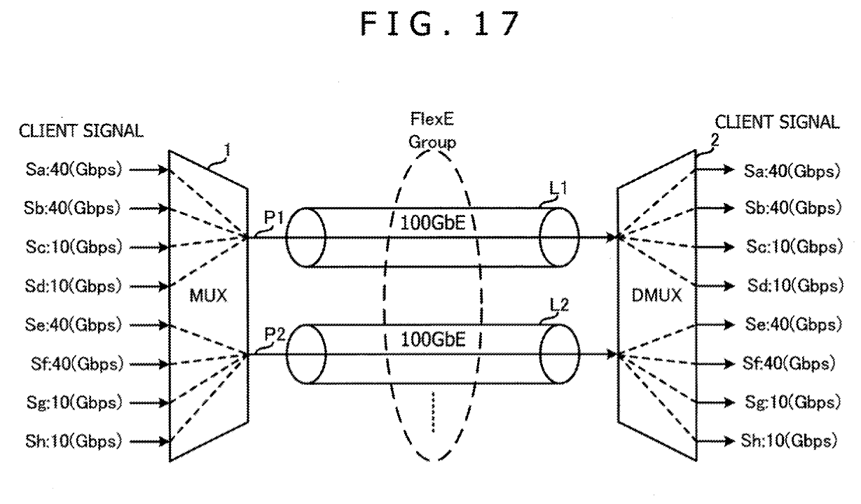

FIG. 17 is a diagram illustrating an example of a transmission system in a case of transmitting plural pairs of client signals Sa to Sh at the same transmission rate. In FIG. 17, the configuration common with FIG. 1 is given the same symbol and description thereof is omitted.

To the signal multiplexing device 1, the client signals Sa, Sb, Se, and Sf of 40 (Gbps) and the client signals Sc, Sd, Sg, and Sh of 10 (Gbps) are input. Suppose that the client signal Sa and the client signal Se, the client signal Sb and the client signal Sf, the client signal Sc and the client signal Sg, and the client signal Sd and the client signal Sh are in the relationship between the in-use system and the backup system.

The client signals Sa to Sd are accommodated in multiplexed frames #1 and are transmitted to the signal demultiplexing device 2 through the communication line L1. Furthermore, the client signals Se to Sh are accommodated in multiplexed frames #2 and are transmitted to the signal demultiplexing device 2 through the communication line L2.

The signal demultiplexing device 2 receives multiplexed frames #1 through the communication line L1 and demultiplexes the client signals Sa to Sd from multiplexed frames #1 to output the client signals Sa to Sd. Furthermore, the signal demultiplexing device 2 receives multiplexed frames #2 through the communication line L2 and demultiplexes the client signals Se to Sh from multiplexed frames #2 to output the client signals Se to Sh.

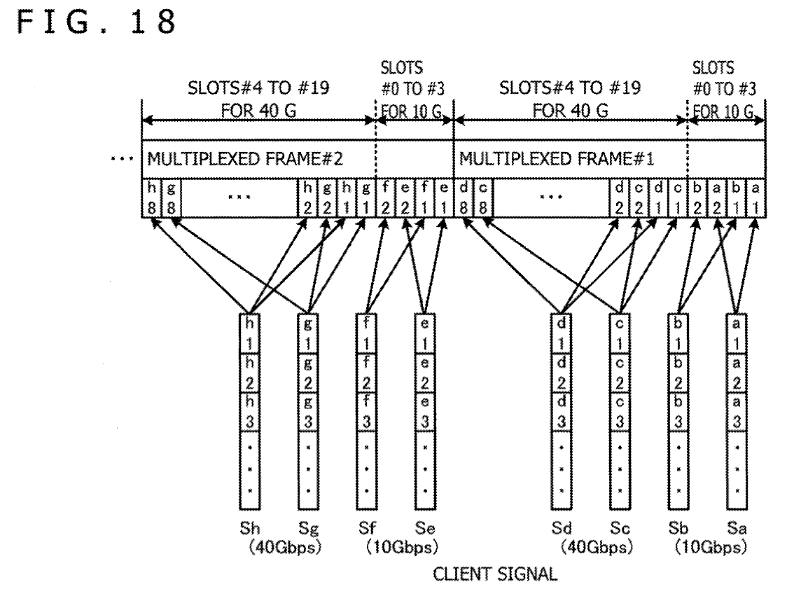

FIG. 18 is a diagram illustrating one example of multiplexing processing in a case in which slots of multiplexed frames are fixed on each transmission rate basis. It is to be noted that the slots of multiplexed frames illustrated in FIG. 18 may be the slots #0 to #19 of multiplexed frames #1 and #2 illustrated in FIG. 6. In FIG. 18, description is omitted regarding contents common with FIG. 6.

As one example, slots #0 to #3 of multiplexed frames #1 and #2 are used as slots for 10 G for accommodating the client signals of 10 (Gbps). Furthermore, slots #4 to #19 of multiplexed frames #1 and #2 are used as slots for 40 G for accommodating the client signals of 40 (Gbps).

Due to this, data a1 and a2 of the client signal Sa and data b1 and b2 of the client signal Sb are accommodated in slots #0 to #3 of multiplexed frame #1. Data c1 to c8 of the client signal Sc and data d1 to d8 of the client signal Sd are accommodated in slots #4 to #19 of multiplexed frame #1.

Furthermore, data e1 and e2 of the client signal Se and data f1 and f2 of the client signal Sf are accommodated in slots #0 to #3 of multiplexed frame #2. Moreover, data g1 to g8 of the client signal Sg and data h1 to h8 of the client signal Sh are accommodated in slots #4 to #19 of multiplexed frame #2.

As above, because the slots of multiplexed frames #1 and #2 are fixed on each transmission rate basis, the number of slots as the selection target of the selectors 125 is reduced according to the transmission rates of the client signals and the circuit scale of the selectors 125 is reduced.

Furthermore, in “calendar (side A)” and “calendar (side B)” of the FlexE overhead, the output destination port number and the input source port number of 8 (Bit) are included as illustrated in FIG. 7. The output destination port number prescribes the correspondence relationship between slots #0 to #19 of multiplexed frames #1 or #2 and the transmitting ports 211 of the signal demultiplexing device 2. Furthermore, the input source port number is used for identification of the client signal in the signal demultiplexing device 2, for example.

If the output destination port number and the input source port number are prescribed in “calendar (side A)” and “calendar (side B)” as above, the output destination port number and the input source port number may be specified from a range of #0 to #15. However, “calendar (side A)” and “calendar (side B)” are not limited to the above description.

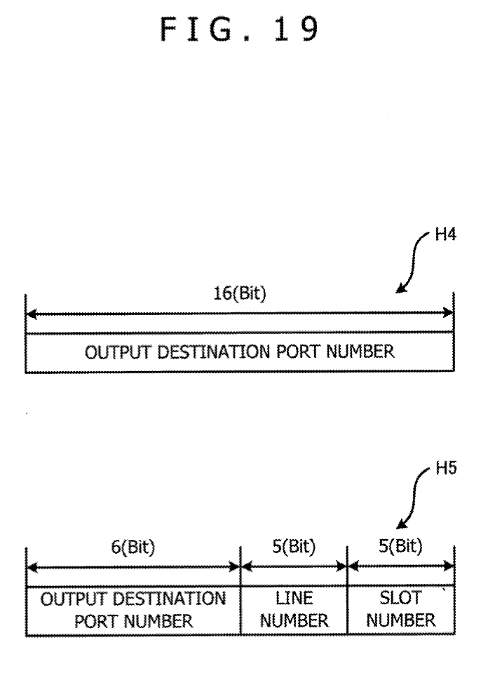

FIG. 19 is a diagram illustrating modification examples of contents of a calendar. For example, as represented by symbol H4, only the output destination port number of 16 (Bit) may be included in “calendar (side A)” and “calendar (side B).” According to the present example, the range of the output destination port number may be extended to #0 to #255.

Furthermore, as represented by symbol H5, the output destination port number of 6 (Bit), a line number of 5 (Bit), and a slot number of 5 (Bit) may be included in “calendar (side A)” and “calendar (side B).” According to the present example, the range of the output destination port number may be extended to #0 to #63.

Moreover, specifying of the communication lines L1 and L2 is enabled by the line number and specifying of slots #0 to #19 is enabled by the slot number. Due to this, management of client signals becomes easy in the signal demultiplexing device 2.

The above-described embodiment is a preferred example of implementation of the disclosed techniques. However, the disclosed techniques are not limited thereto and may be carried out with various modifications without departing from the gist of the disclosed techniques.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission device in a transmission system in which a first transmission device transmits frames to a second transmission device, the transmission device as the first transmission device comprising:
a first memory; and
a first processor coupled to the first memory and the first processor configured to:
generate a first frame having a plurality of first slots to be transmitted to the second transmission device through a first path, and a second frame having a plurality of second slots to be transmitted to the second transmission device through a second path;
arrange data into one of the plurality of first slots and the plurality of second slots;
notify the second transmission device of first information of an output destination of the data arranged into the plurality of first slots through the first path in a first case where the data is arranged into the plurality of first slots; and
notify the second transmission device of second information of a correspondence relationship between the plurality of second slots and the output destination through the second path, in a second case where the data is arranged from the plurality of first slots into the plurality of second slots, before the data being arranged from the plurality of first slots to the plurality of second slots.

2. The transmission device according to claim 1,
wherein the first processor is configured to stop transmission of the first frame when data to be arranged into the plurality of first slots does not exist, in the case where the data is arranged from the plurality of first slots into the plurality of second slots, after the data being arranged from the plurality of first slots into the plurality of second slots.

3. The transmission device according to claim 1,
wherein the first processor is configured to select one of the plurality of first slots and the plurality of second slots into which the data is arranged, based on a transmission rate of the data.

4. The transmission device according to claim 1,
wherein the first processor is configured to notify the second transmission device of the first information or the second information by an overhead frame based on Flex Ethernet generated in each of the first frame and the second frame.

5. The transmission device according to claim 4,
wherein the overhead frame based on Flex Ethernet includes calendar information for indicating the output destination.

6. The transmission device according to claim 1,
wherein the transmission device as the second transmission device includes a second memory and a second processor coupled to the second memory, and the second processor is configured to:
receive the first frame and the second frame;
acquire the data from one of the plurality of first slots and the plurality of second slots;
receive the first information and acquire the data from the plurality of first slots of the first frame in the first case; and
receive the second information and acquire the data from the plurality of second slots of the second frame in the second case.

7. A transmission method in a transmission system in which a first transmission device transmits frames to a second transmission device, the transmission method of a transmission device as the first transmission device comprising:
generating a first frame having a plurality of first slots to be transmitted to the second transmission device through a first path, and a second frame having a plurality of second slots to be transmitted to the second transmission device through a second path;
arranging data into one of the plurality of first slots and the plurality of second slots;
notifying the second transmission device of first information of an output destination of the data arranged into the plurality of first slots through the first path in a first case where the data is arranged into the plurality of first slots; and
notifying the second transmission device of second information of a correspondence relationship between the plurality of second slots and the output destination through the second path, in a second case where the data is arranged from the plurality of first slots into the plurality of second slots, before the data being arranged from the plurality of first slots to the plurality of second slots, by a first processor.

8. The transmission method according to claim 7,
wherein the first processor is configured to stop transmission of the first frame when data to be arranged into the plurality of first slots does not exist, in the case where the data is arranged from the plurality of first slots into the plurality of second slots, after the data being arranged from the plurality of first slots into the plurality of second slots.

9. The transmission method according to claim 7,
wherein the first processor is configured to select one of the plurality of first slots and the plurality of second slots into which the data is arranged, based on a transmission rate of the data.

10. The transmission method according to claim 7,
wherein the first processor is configured to notify the second transmission device of the first information or the second information by an overhead frame based on Flex Ethernet generated in each of the first frame and the second frame.

11. The transmission method according to claim 10,
wherein the overhead frame based on Flex Ethernet includes calendar information for indicating the output destination.

12. The transmission method according to claim 7,
wherein the second transmission device includes a second memory and a second processor coupled to the second memory, and the second processor is configured to:
receive the first frame and the second frame;
acquire the data from one of the plurality of first slots and the plurality of second slots;
receive the first information and acquire the data from the plurality of first slots of the first frame in the first case; and
receive the second information and acquire the data from the plurality of second slots of the second frame in the second case.
